(19) United States
(12) Patent Application Publication
(10) Pub. No.: US 2015/0286749 A1
(43) Pub. Date: Oct. 8, 2015

(54) WHOLE INTEGRATED ANALYSIS MODEL CREATION ASSIST DEVICE, AND WHOLE INTEGRATED ANALYSIS MODEL CREATION ASSIST METHOD

(71) Applicant: Hitachi, Ltd., Tokyo (JP)

(72) Inventors: Norihiko NONAKA, Tokyo (JP); Kazuyuki SUGIMURA, Tokyo (JP)

(21) Appl. No.: 14/640,164

(22) Filed: Mar. 6, 2015

(30) Foreign Application Priority Data
Apr. 4, 2014 (JP) 2014-078038

(51) Int. Cl. G06F 17/50

(52) U.S. Cl. CPC G06F 17/50

(57) ABSTRACT

Provided is a whole integrated analysis model creation assist device and a whole integrated analysis model creation assist method such that an analysis model can be easily constructed and the construction time of the analysis model can be effectively reduced. Via a connection identifier associating boundaries for data exchange between an analysis model created with respect to one analysis domain and an analysis model created with respect to another analysis domain, at least one analysis model created with respect to the one analysis domain and a plurality of analysis models created with respect to the other analysis domain are connected and integrated.

### BACKGROUND

1. Technical Field

The present invention relates to a whole integrated analysis model creation assist device and a whole integrated analysis model creation assist method, such as a whole integrated analysis model creation assist device and a whole integrated analysis model creation assist method for assisting the creation of a whole integrated analysis model used when calculating the performance, such as efficiency, of a system as a whole of a mechanical structure, such as a fluid pump.

2. Background Art

Conventionally, in analysis for calculating the performance of a mechanical structure such as a fluid pump, a technology is known whereby, when constructing an analysis model used for the analysis, analytical calculation is performed by switching analysis models with different levels of detail in accordance with analysis conditions. An example of this type of conventional technology is disclosed in Patent Document 1.

Patent Document 1 discloses a simulation control device including a model selection unit that selects a simulation model on the basis of a selection condition set from a condition input unit. The simulation model is read from a model database, and a simulation calculation unit, using the simulation model, performs simulation calculation based on an initial state and a simulation condition that are set in the condition input unit, whereby the simulation calculation is performed by switching simulation models with different levels of detail on the basis of the model selection condition. For example, for an important portion, high-accuracy simulation is performed using a model with high level of detail, while for a not-so-important portion, simulation is performed in a short time using a model with low level of detail.

A technology is also known that describes link information for associating different information, such as a CAD model and cost data. An example of this type of conventional technology is disclosed in Patent Document 2.

Patent Document 2 discloses a wire harness cost calculation system provided with a CAD device and a cost calculation device. In the CAD device, when a constituent element figure representing a wire harness electric cable or component is placed on a drawing, a corresponding record is described in CAD model data, whereas, when constituent element figures are placed in a mutually related manner, record link information is described in the CAD model data. In the cost calculation device, based on record and link information included in CAD model data, an electric cable length, the type and number of components, and processing work are calculated. A database is enquired about the unit cost of the electric cables and components and about the unit man-hour of the processing work so as to calculate the cost of a wire harness.

### RELATED ART DOCUMENTS

### Patent Documents

Patent Document 1: JP 2002-259888 A

Patent Document 2: JP 2009-80744 A

### SUMMARY

In the conventional technology disclosed in Patent Document 1, the analysis models with different levels of detail are switched in accordance with the analysis conditions so that high-accuracy simulation is performed using a model with high level of detail for an important portion, while simulation is performed using a model with low level of detail for a portion that is not so important. In such conventional technology, when analytical calculation is performed, it is necessary to construct an analysis model by connecting analysis models, such as the analysis model for the important portion and the analysis model for the not-so-important portion, in an analysis domain. Specifically, at the boundary of the connected analysis models, it is necessary to mutually exchange data as a boundary condition. For example, when the degree of importance is high in a certain analysis domain, an analysis model with high level of detail, such as three-dimensional finite element method, is applied. When the degree of importance is low, an analysis model with low level of detail, such as one-dimensional finite element method, is applied. In this example, when the degree of importance is high, the operator needs to identify the boundary between the analysis model utilized by the three-dimensional finite element method and the connected analysis model for the one-dimensional finite element method, and to provide the boundary condition. When the degree of importance is low, the operator needs to identify the boundary between the analysis model utilized by the one-dimensional finite element method and the connected analysis model for the three-dimensional finite element method, and to again provide the boundary condition.

In the conventional technology disclosed in Patent Document 1, as described above, each time the analysis models with different levels of detail are switched, the operator needs to identify the boundary and provide its boundary condition. Thus, it takes much time and man-hour for constructing the analysis model. However, currently there has not been sufficient consideration given to the issue of how to save the labor for setting the boundary condition of the connected analysis models and reduce the construction time of the analysis model.

In the conventional technology disclosed in Patent Document 2, when the different information such as the CAD model and cost data are related, link information is described to associate the data. For example, in connected analysis domains A and B, there are respectively analysis models A^{F} and B^{F} with high levels of detail and analysis models A^{C} and B^{C} with low levels of detail. In this example, the superscript index F means a high level of detail analysis model, while the superscript index C means a low level of detail analysis model. Because the analysis domains A and B are mutually connected, it is necessary to provide the connected boundary with a boundary condition for data exchange. In this case, according to the conventional technology using link information, it is necessary for the operator to designate the boundary of A^{C} and B^{C} in the link information of the boundary connected with A^{F} to describe the link information, and also to designate the boundary of A^{C} and B^{C} in the link information of the boundary connected with B^{F} to described the link information.

In the conventional technology described in Patent Document 2, as described above, because of the need for comprehensively describing the link information for each analysis model, it takes much time and man-hour for constructing the analysis model. However, currently there has not been sufficient consideration given to the issue of how to save the labor for setting the boundary condition of the connected analysis models and reduce the construction time of the analysis model.

The present invention has been made in view of the above problem, and an object of the present invention is to provide a whole integrated analysis model creation assist device and a whole integrated analysis model creation assist method such that an analysis model can be easily constructed and the construction time of the analysis model can be effectively reduced.

In order to solve the above problem, a whole integrated analysis model creation assist device according to the present invention for assisting creation of a whole integrated analysis model integrating analysis models created with respect to a plurality of analysis domains is configured to connect and integrate at least one analysis model created with respect to one of the analysis domains with a plurality of analysis models created with respect to another of the analysis domains via a connection identifier associating boundaries for data exchange between the analysis model created with respect to the one analysis domain and the analysis model created with respect to the other analysis domain.

A whole integrated analysis model creation assist method according to the present invention for assisting creation of a whole integrated analysis model integrating analysis models created with respect to a plurality of analysis domains includes connecting and integrating at least one analysis model created with respect to one of the analysis domains with a plurality of analysis models created with respect to another of the analysis domains via a connection identifier associating boundaries for data exchange between the analysis model created with respect to the one analysis domain and the analysis model created with respect to the other analysis domain.

As will be understood from the foregoing description, according to the present invention, via a connection identifier associating boundaries for data exchange between an analysis model created with respect to one analysis domain and an analysis model created with respect to another analysis domain, at least one analysis model created with respect to the one analysis domain and a plurality of analysis models created with respect to the other analysis domain are connected and integrated. In this way, even when analysis models with different levels of detail are switched, for example, the man-hour for constructing the whole integrated analysis model connecting the analysis models of the respective analysis domains can be reduced, and the construction time of the analysis model can be effectively reduced.

Other problems, configurations, and effects will become apparent from the following description of an embodiment.

### BRIEF DESCRIPTION OF DRAWINGS

FIG. 1 is an overall configuration diagram illustrating the overall configuration of a whole integrated analysis model creation assist device according to an embodiment of the present invention.

FIG. 2 is a vertical cross sectional view of an example of a mechanical structure as the object of analysis.

FIG. 3 is a flowchart describing a first phase of a whole integrated analysis model creation assist method according to the present invention.

FIG. 4 is a flowchart describing a second phase of the whole integrated analysis model creation assist method according to the present invention.

FIG. 5 illustrates an example of an analysis model input screen (the analysis model input screen for a pressurizing chamber with the level of analysis detail of level 2).

FIG. 6 illustrates an example of the analysis model input screen (the analysis model input screen for a discharge valve with the level of analysis detail of level 1).

FIG. 7 illustrates an example of the analysis model input screen (the analysis model input screen for a discharge valve with the level of analysis detail of level 2).

FIG. 8 illustrates an example of the analysis model input screen (the analysis model input screen for a discharge valve with the level of analysis detail of level 3).

FIG. 9 illustrates an example of the analysis condition input screen (the analysis condition input screen for the pressurizing chamber with the level of analysis detail of level 2).

FIG. 10 illustrates an example of the analysis condition input screen (the analysis condition input screen for the discharge valve with the level of analysis detail of level 1).

FIG. 11 illustrates an example of the analysis condition input screen (the analysis condition input screen for the discharge valve with the level of analysis detail of level 2).

FIG. 12 illustrates an example of the analysis condition input screen (the analysis condition input screen for the discharge valve with the level of analysis detail of level 3).

FIG. 13 illustrates an example of a boundary connection information input screen (the boundary connection information input screen for the pressurizing chamber with the level of analysis detail of level 2).

FIG. 14 illustrates an example of the boundary connection information input screen (the boundary connection information input screen for the discharge valve with the level of analysis detail of level 1).

FIG. 15 illustrates an example of the boundary connection information input screen (the boundary connection information input screen for the discharge valve with the level of analysis detail of level 2).

FIG. 16 illustrates an example of the boundary connection information input screen (the boundary connection information input screen for the discharge valve with the level of analysis detail of level 3).

FIG. 17 illustrates an example of a screen for confirming the connection relationship between the analysis models.

FIG. 18 illustrates an example of an analysis execution process input screen.

FIG. 19 illustrates an example of an analysis result display screen.

FIG. 20 illustrates another example of the analysis execution process input screen.

### DETAILED DESCRIPTION OF THE EMBODIMENT

In the following, an embodiment of the whole integrated analysis model creation assist device and the whole integrated analysis model creation assist method according to the present invention will be described with reference to the drawings.

### Embodiment of Whole Integrated Analysis Model Creation Assist Device

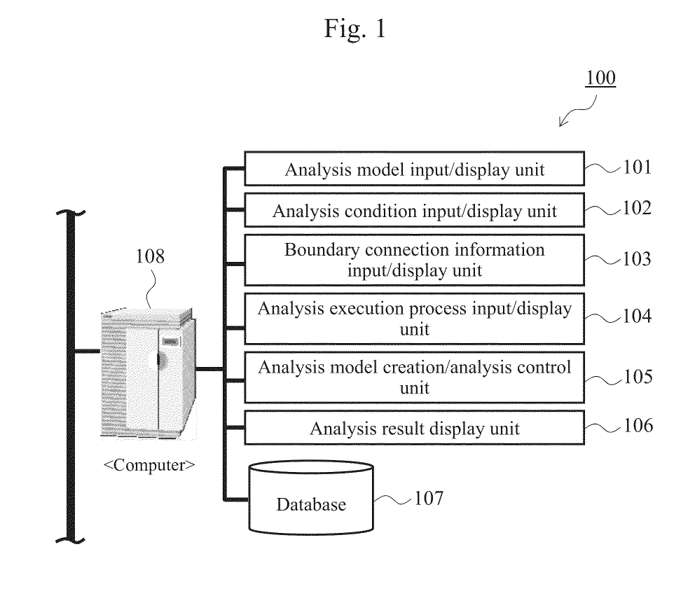

FIG. 1 is an overall configuration diagram illustrating the system configuration of an embodiment of the whole integrated analysis model creation assist device according to the present invention. The whole integrated analysis model creation assist device 100 mainly includes an analysis model input/display unit 101, an analysis condition input/display unit 102, a boundary connection information input/display unit 103, an analysis execution process input/display unit 104, an analysis model creation/analysis control unit 105, an analysis result display unit 106, a database 107, and a computer 108, which are communicably connected.

The analysis model input/display unit 101 displays an analysis model input screen. The analysis model input/display unit 101 displays analysis model information input by the operator, such as an analysis model, a level of analysis detail, and an analysis type, on the analysis model input screen and inputs the input information into the database 107.

The “level of analysis detail” refers to information indicating the level of detail of analysis model, such as the analysis model being a one-dimensional model, a two-dimensional model, a three-dimensional model, or a simplified type. For example, the one-dimensional model and the simplified type are defined as “level 3”, the two-dimensional model is defined as “level 2”, and the three-dimensional model is defined as “level 1”.

The “analysis type” is information indicating the mode of analysis model, such as the analysis model being a shape base or a simplified type.

The analysis condition input/display unit 102 displays an analysis condition input screen. The analysis condition input/display unit 102, with respect to the analysis model input via the analysis model input/display unit 101, displays analysis condition information input by the operator, such as an entry boundary condition, an exit boundary condition, an analysis condition, and main variable or dependent variable conditions, on the analysis condition input screen, and inputs the input information into the database 107.

The boundary connection information input/display unit 103 displays a boundary connection information input screen. The boundary connection information input/display unit 103, with respect to the analysis model input via the analysis model input/display unit 101, displays boundary connection information input by the operator, such as an analysis model connection position, a connected portion of an approximation formula to a variable, an analysis name, and a connection identifier, on the boundary connection information input screen, and inputs the input information into the database 107. The boundary connection information input/display unit 103 may also be configured to visualize a connection relationship between the analysis models via the connection identifier on the basis of the input boundary connection information, and display the connection relationship on the screen.

The “connection identifier” herein refers to an identifier associating, in an analytical calculation for calculating the performance of a mechanical structure, boundaries for the exchange of data between analysis models or variables related to the boundaries.

The analysis execution process input/display unit 104 displays an analysis execution process input screen. The analysis execution process input/display unit 104 displays analysis execution process information input by the operator, such as an analysis model name, a level of analysis detail, and received data corresponding to the number of analysis domains, and the maximum number of repetitions, convergence determination, the maximum time step, and a time step, on the analysis execution process input screen, and inputs the input information into the database 107.

The analysis model creation/analysis control unit 105 acquires the information input via the analysis model input/display unit 101, the analysis condition input/display unit 102, the boundary connection information input/display unit 103, and the analysis execution process input/display unit 104, and, based on the information concerning the connection identifier input via the boundary connection information input/display unit 103 and the level of analysis detail input via the analysis execution process input/display unit 104, constructs an analysis model (whole integrated analysis model) connecting a plurality of analysis domains using the analysis model input via the analysis model input/display unit 101, and mesh-generates the analysis model as necessary. The analysis model creation/analysis control unit 105 also, based on the received data input via the analysis execution process input/display unit 104, sets a connection destination boundary condition, and executes performance analysis for the mechanical structure under the analysis condition input via the analysis condition input/display unit 102. The analysis model creation/analysis control unit 105 repeats the execution of the analysis in all analysis domains, and, at the end of the analysis, inputs an analysis result into the database 107.

The analysis result display unit 106 acquires the result of analysis by the analysis model creation/analysis control unit 105 from the database 107, and displays the result of analysis to the operator and the like.

The database 107 accumulates the information (data) obtained by the analysis model input/display unit 101, the analysis condition input/display unit 102, the boundary connection information input/display unit 103, the analysis execution process input/display unit 104, the analysis model creation/analysis control unit 105, and the analysis result display unit 106.

### Embodiment of Whole Integrated Analysis Model Creation Assist Method

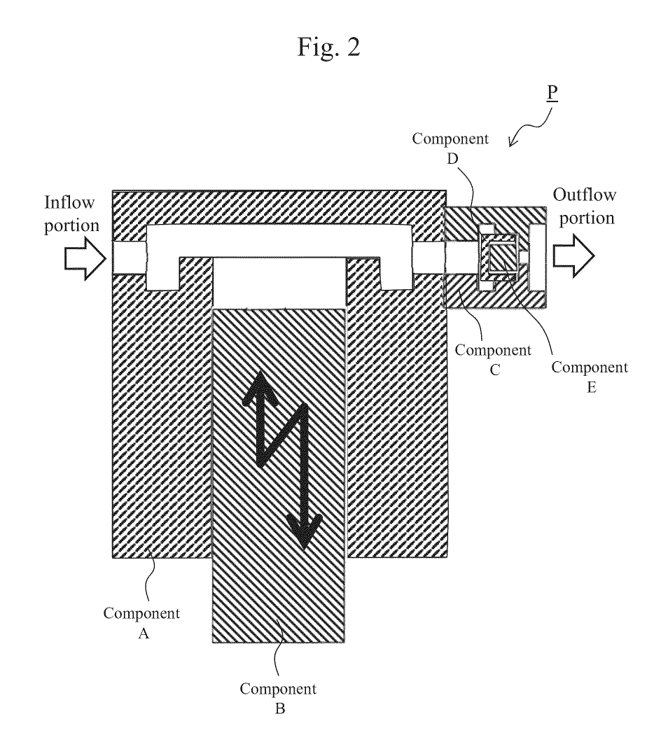

With reference to FIGS. 2 to 20, a processing procedure of the whole integrated analysis model creation assist device 100 (a whole integrated analysis model creation assist method according to the present invention) will be described in specific terms.

In the following, with reference to a fluid pump as a mechanical structure shown in FIG. 2, for example, a method of constructing an analysis model (whole integrated analysis model) in which a plurality of analysis domains is connected via a connection identifier for whole integrated analysis, and a relevant analysis method will be described.

First, the configuration of the mechanical structure (fluid pump P) as the object of analysis will be generally described. The fluid pump P illustrated in FIG. 2 is an assembly of a total of five components including a component A, a component B, a component C, a component D, and a component E. In the fluid pump P, the component B, which is a plunger, moves up and down. The inside of the fluid pump P (the blank portions in the figure) is filled with fluid. The fluid flows into the fluid pump P via an inflow portion as the plunger (component B) moves downward and the pressure inside the pump drops, causing a valve disposed ahead of the inflow portion to be opened. As the plunger (component B) moves upward from the bottom dead center, the pressure inside the pump increases, causing the valve ahead of the inflow portion to be closed. As the plunger (component B) moves further upward, the pressure inside the pump further increases, causing the component D, which is a discharge valve, to be opened, whereby the fluid flows out of the outflow portion. As the plunger (component B) moves again downward from the top dead center, the pressure inside the pump decreases, and the discharge valve (component D) is closed. The discharge valve is pressurized by a spring (component E), so that the discharge valve is opened or closed in accordance with an increase or decrease of the pressure inside the pump.

Here, with reference to the fluid pump P, a description will be given of a method of constructing an analysis model for fluid analysis for whole integrated analysis connecting two analysis domains of a flow passageway portion (the blank portions in the figure) of a pressurizing chamber including component A and component B, and a flow passageway portion of the discharge valve including component C, component D, and component E. A relevant analysis method will also be described.

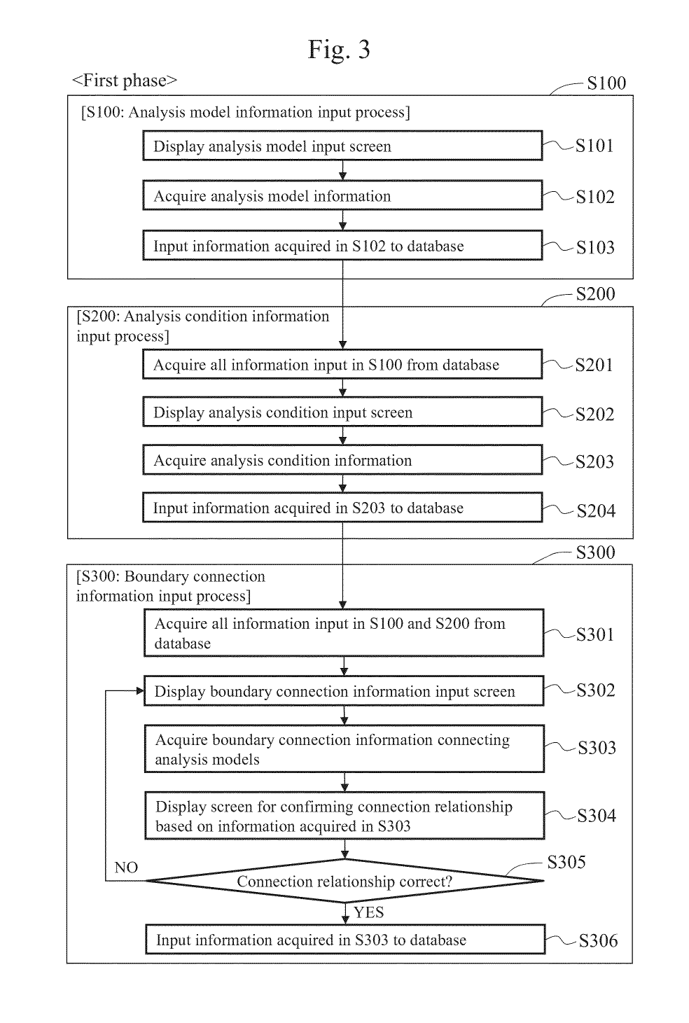

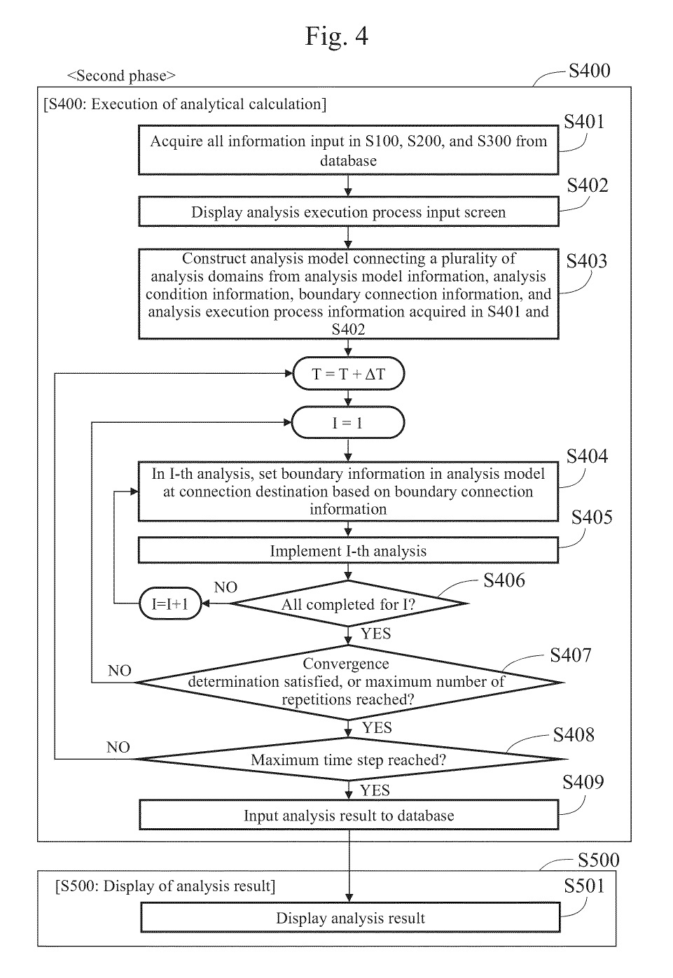

The processing procedure of the whole integrated analysis model creation assist device 100 (the whole integrated analysis model creation assist method according to the present invention) is mainly divided into two phases. One phase (first phase) is a phase of inputting analysis model information, analysis condition information, and boundary connection information. The other phase (second phase) is a phase of inputting analysis execution process information, constructing an analysis model (whole integrated analysis model) connecting a plurality of analysis domains from the information input in the first phase, executing performance analysis of the analysis model, and displaying the analysis result. FIG. 3 and FIG. 4 show flowcharts of the first phase and the second phase respectively of the processing procedure in the whole integrated analysis model creation assist device 100 of FIG. 1.

As shown in FIG. 3, first, in S100 of the first phase, the analysis model information is input by the analysis model input/display unit 101.

Specifically, in S101 of S100, the analysis model input/display unit 101 displays an input screen for analysis model information. Via the analysis model input screen, the operator inputs analysis model information concerning an analysis model to be analyzed.

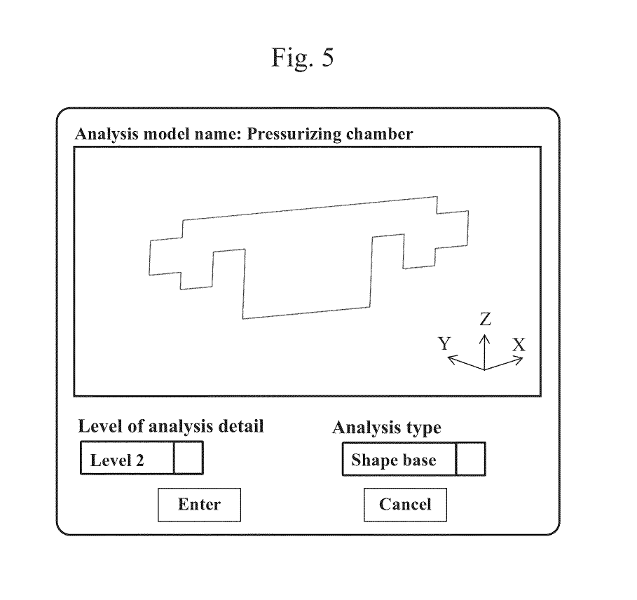

FIG. 5 illustrates an example of the analysis model input screen, where the operator has input a two-dimensional model of the flow passageway portion of the pressurizing chamber. As an analysis model name, “pressurizing chamber” is input, and as a level of analysis detail, “level 2” is input (the level of analysis detail is level 2 because a two-dimensional model is the object). Because the input analysis model has a shape, “shape base” is input as an analysis type.

Similarly, the operator also inputs an analysis model of the discharge valve via the analysis model input screen. Herein for the discharge valve, a plurality of analysis models having different levels of analysis detail is input.

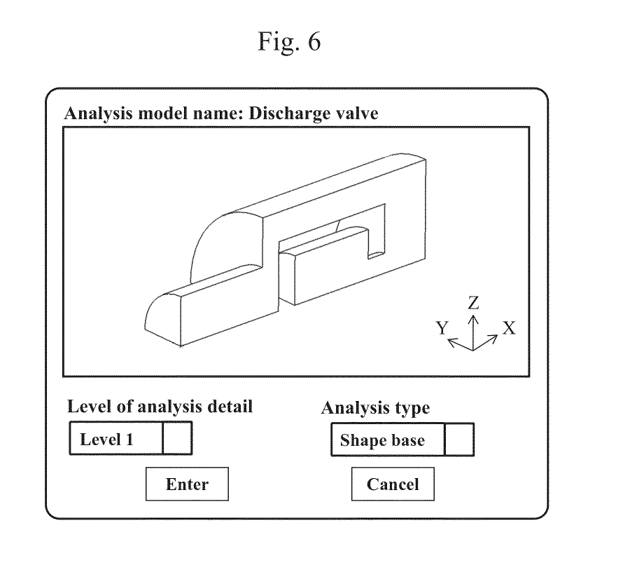

First, the operator inputs an analysis model with the highest level of analysis detail. FIG. 6 illustrates an example of the analysis model input screen, where the operator has input a three-dimensional model of the flow passageway portion of the discharge valve as the analysis model with the highest level of analysis detail. As the analysis model name, “discharge valve” is input, and as the level of analysis detail, “level 1” is input (the level of analysis detail is level 1 because a three-dimensional model is the object). As the analysis type, “shape base” is input.

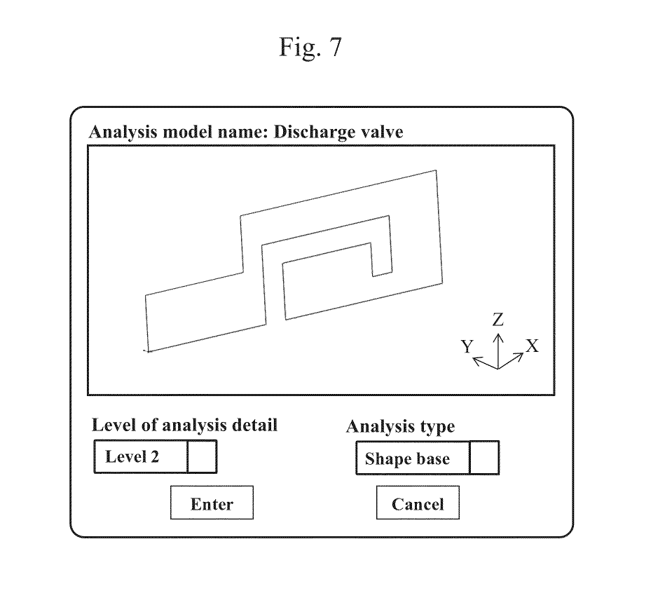

The operator then inputs an analysis model with the second highest level of analysis detail. FIG. 7 illustrates an example of the analysis model input screen, where the operator has input a two-dimensional model of the flow passageway portion of the discharge valve. As the analysis model name, “discharge valve” is input, and as the level of analysis detail, “level 2” is input (because a two-dimensional model is the object). As the analysis type, “shape base” is input.

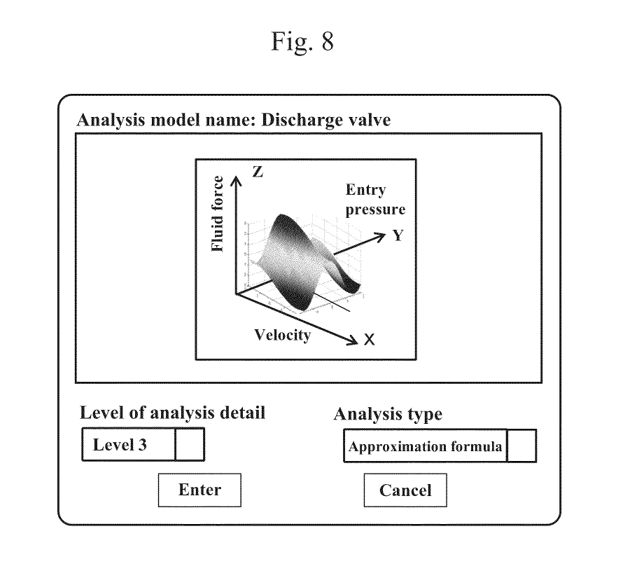

Finally, the operator inputs an analysis model with the lowest level of analysis detail. FIG. 8 illustrates an example of the analysis model input screen, where the operator has input a polynomial expressing the behavior of the discharge valve given by expression (1) given below, for example, and its distribution as the analysis model. As the analysis model name, “discharge valve” is input, and as the level of analysis detail, “level 3” is input (the level of analysis detail is level 3 because the analysis model is expressed by an approximation formula). Because the input analysis model does not have a shape, “approximation formula” is input as the analysis type.

Z=a+bx+cy+dxy+ex²+fy²+gx²y+hxy²+ix²y² (1)

The sequence of input of the analysis model information by the operator in S101 may be random.

In S102 of S100, the analysis model names, analysis models, levels of analysis detail, and analysis types of the pressurizing chamber and the discharge valve input in S101 are acquired by the analysis model input/display unit 101.

In S103 of S100, the information obtained in S102 is input into the database 107 by the analysis model input/display unit 101.

Then, in S200 of the first phase, analysis condition information is input by the analysis condition input/display unit 102.

Specifically, in S201 of S200, the information input by the analysis model input/display unit 101 in S100 is acquired from the database 107 by the analysis condition input/display unit 102.

In S202 of S200, the analysis condition input/display unit 102 displays an input screen for analysis condition information. The operator inputs analysis condition information for analysis via the analysis condition input screen.

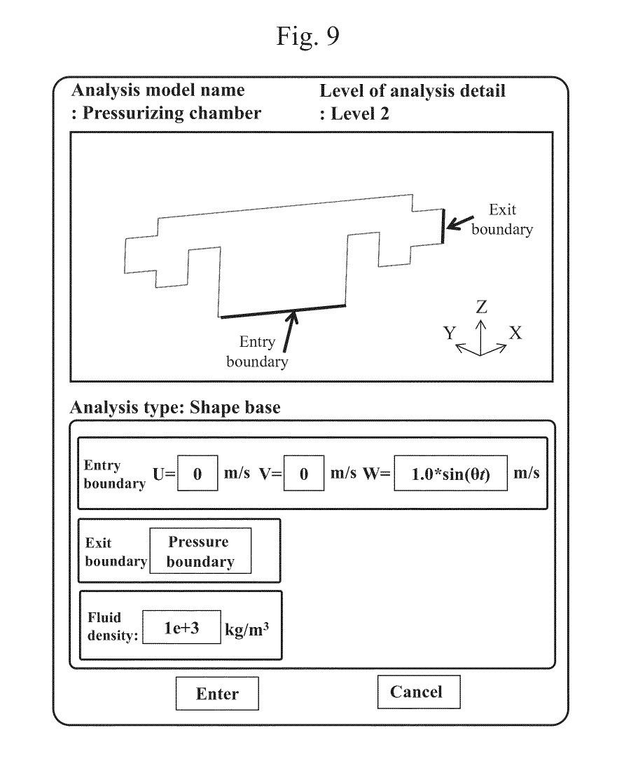

FIG. 9 illustrates an example of the analysis condition input screen, which is a screen for inputting the analysis condition information with respect to the analysis model of the pressurizing chamber shown in FIG. 5. Herein, a two-dimensional model of the flow passageway portion of the pressurizing chamber is input. There are also displayed the analysis model name “pressurizing chamber”, the level of analysis detail “level 2”, and the analysis type “shape base” that have been input by the analysis model input/display unit 101. Herein, the operator inputs the analysis condition information for two-dimensional fluid analysis, an entry boundary at a location where fluid flows in, and an exit boundary at a location where the fluid flows out. The entry boundary and the exit boundary may be input via the analysis condition input screen, for example. As the analysis condition information for the entry boundary, there are input “0” m/s for flow velocity U in the x-direction, “0” m/s for flow velocity V in the y-direction, and “1.0*sin(θt)” m/s for flow velocity W in the z-direction, where θ is the rotation angle of the plunger per unit time, and t is the progressing time during analysis. For the entry boundary, while the plunger is in fact moved up and down, the flow velocity W is periodically given for substitution. As the analysis condition information for the exit boundary, “pressure boundary” is input, and “le+3” kg/m³ is input for the fluid density.

Similarly, the operator also inputs analysis condition information of the discharge valve via the analysis condition input screen.

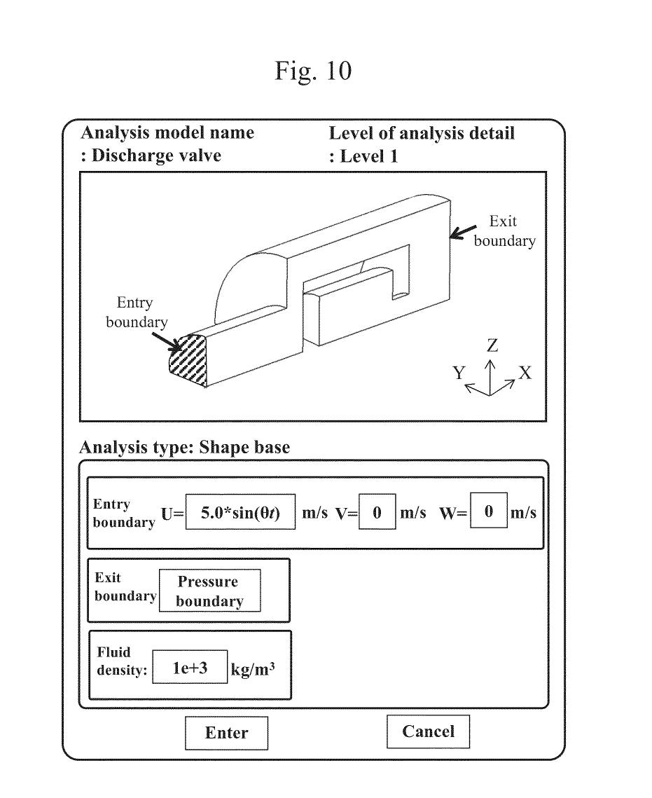

First, the operator inputs the analysis condition information with respect to the analysis model of the discharge valve with the level of analysis detail “level 1” shown in FIG. 6. FIG. 10 illustrates an example of the analysis condition input screen, where a three-dimensional model of the flow passageway portion of the discharge valve is input. There are also displayed the analysis model name “discharge valve”, the level of analysis detail “level 1”, and the analysis type “shape base” that have been input by the analysis model input/display unit 101. Herein, the operator inputs the analysis condition information for three-dimensional fluid analysis, an entry boundary at a location where the fluid flows in, and an exit boundary at a location where the fluid flows out. Further, as the analysis condition information for the entry boundary, there are input “5.0*sin(θt)” m/s for flow velocity U in the x-direction, “0” m/s for flow velocity V in the y-direction, and “0” m/s for flow velocity W in the z-direction. With regard to the entry boundary, the flow velocity U is periodically given based on the up-down motion of the plunger. For the exit boundary, “pressure boundary” is input, and “1e+3” kg/m³ is input for the fluid density.

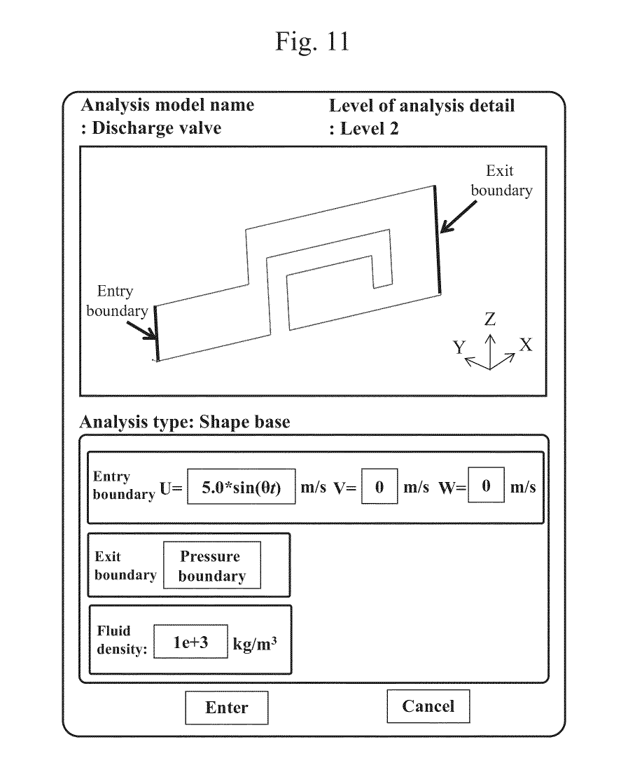

Then, the operator inputs the analysis condition information with respect to the analysis model of the discharge valve with the level of analysis detail of “level 2” show in FIG. 7. FIG. 11 illustrates an example of the analysis condition input screen, where a two-dimensional model of the flow passageway portion of the discharge valve is input. There are also displayed the analysis model name “discharge valve”, the level of analysis detail “level 2”, and the analysis type “shape base” that have been input by the analysis model input/display unit 101. Herein, the operator inputs the analysis condition information for two-dimensional fluid analysis, the entry boundary at a location where the fluid flows in, and the exit boundary at a location where the fluid flows out. Further, as the analysis condition information for the entry boundary, similarly to the above-described analysis condition information with respect to the analysis model of the discharge valve with “level 1”, there are input “5.0*sin(θt)” m/s for the flow velocity U in the x-direction, “0” m/s for the flow velocity V in the y-direction, and “0” m/s for the flow velocity W in the z-direction, and, for the exit boundary, “pressure boundary” is input and “le+3” kg/m³ is input for the fluid density.

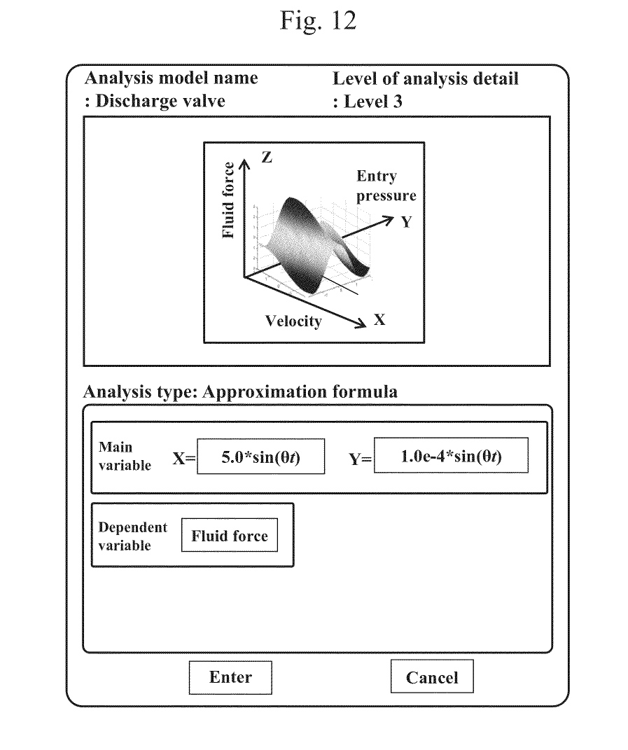

Finally, the operator inputs the analysis condition information with respect to the analysis model of the discharge valve with the level of analysis detail of “level 3” shown in FIG. 8. FIG. 12 illustrates an example of the analysis condition input screen, where an approximation formula of the discharge valve is input and, as an analysis model, a graph visualizing the approximation formula is displayed. There are also displayed the analysis model name “discharge valve”, the level of analysis detail “level 3”, and the analysis type “approximation formula ” that have been input by the analysis model input/display unit 101. Herein, the operator inputs the analysis condition information for approximation formula calculation, and as input values, “5.0*sin(θt)” m/s is input in the main variable X and “1.0e-4*sin(θt)” m/s is input in Y. The main variables refer to the flow rate and discharge valve entry pressure, for which values based on the up-down motion of the plunger are input. In the dependent variable as an output value, “fluid force” is input.

The sequence of the input of the analysis condition information by the operator in S202 may be random.

In S203 of S200, analysis condition information, such as the analysis condition information input in S202, is acquired by the analysis condition input/display unit 102.

In S204 of S200, the information obtained in S203 is input to the database 107 by the analysis condition input/display unit 102.

Then, in S300 of the first phase, the boundary connection information is input by the boundary connection information input/display unit 103.

Specifically, in S301 of S300, the information input by the analysis model input/display unit 101 and the analysis condition input/display unit 102 in S100 and S200 are acquired from the database 107 by the boundary connection information input/display unit 103.

In S302 of S300, the boundary connection information input screen is displayed by the boundary connection information input/display unit 103. Via the boundary connection information input screen, the operator inputs boundary connection information connecting (relating), with a connection identifier, the analysis models present in the two analysis domains of the flow passageway portion of the pressurizing chamber and the flow passageway portion of the discharge valve.

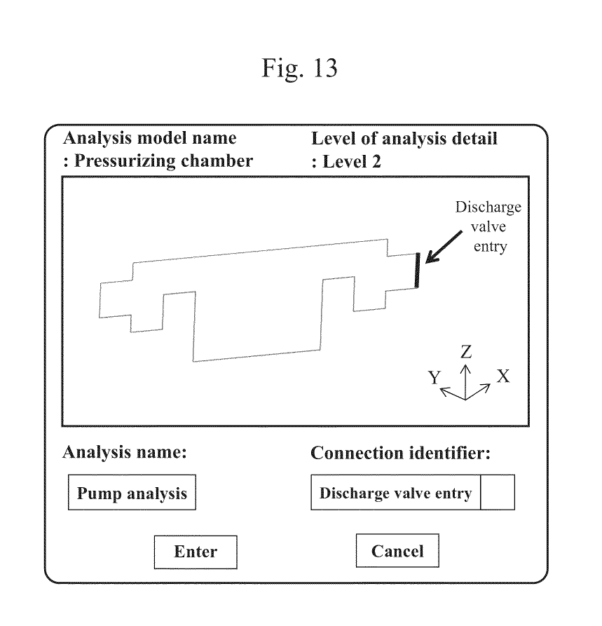

FIG. 13 illustrates an example of the boundary connection information input screen, which is a screen for inputting, with respect to the analysis model of the pressurizing chamber shown in FIG. 5, the boundary connection information including a connecting boundary and a connection identifier. Herein, a two-dimensional model of the flow passageway portion of the pressurizing chamber is input. There are also displayed the analysis model name “pressurizing chamber” and the level of analysis detail “level 2” that have been input by the analysis model input/display unit 101. Also, in order to provide a name for the connected analysis model, the operator inputs the analysis name “pump analysis”. For a connection identifier name, “discharge valve entry” is input, and a boundary for connection with respect to the two-dimensional model is input. In FIG. 13, the connection identifier “discharge valve entry” is set at the bold line portion of the two-dimensional model.

Next, the operator inputs boundary connection information with respect to the discharge valve via the boundary connection information input screen.

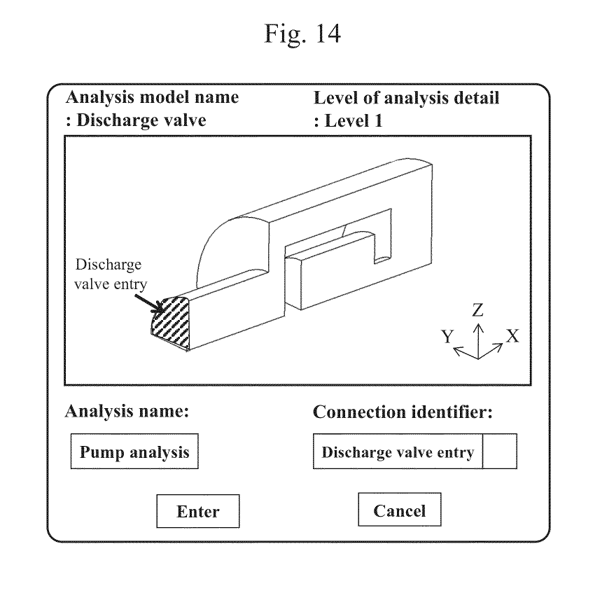

First, the operator inputs the boundary connection information with respect to the analysis model of the discharge valve with the level of analysis detail “level 1” shown in FIG. 6. FIG. 14 illustrates an example of the boundary connection information input screen, where a three-dimensional model of the flow passageway portion of the discharge valve is input. There are also displayed the analysis model name “discharge valve” and the level of analysis detail “level 1” that have been input by the analysis model input/display unit 101. Herein, for connection with the previously input analysis model of the pressurizing chamber, the operator inputs “pump analysis” as the analysis name. Similarly, “discharge valve entry” is input for the connection identifier name, and a boundary for connection with respect to the three-dimensional model is input. In FIG. 14, the connection identifier “discharge valve entry” is set at the portion with hatching of the three-dimensional model.

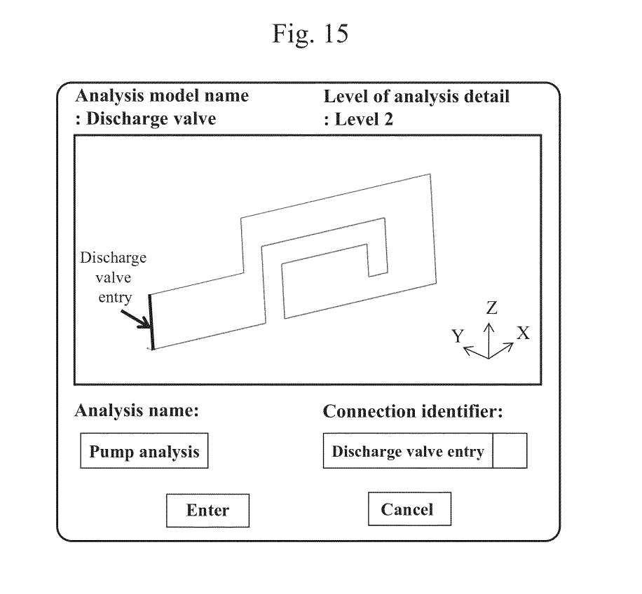

Then, the operator inputs the boundary connection information with respect to the analysis model of the discharge valve with the level of analysis detail “level 2” shown in FIG. 7. FIG. 15 illustrates an example of the boundary connection information input screen, where a two-dimensional model of the flow passageway portion of the discharge valve is input. There are also displayed the analysis model name “discharge valve” and the level of analysis detail “level 2” that have been input by the analysis model input/display unit 101. Herein, for connection with the previously input analysis model of the pressurizing chamber, “pump analysis” is input by the operator as the analysis name. Similarly, “discharge valve entry” is input for the connection identifier name, and a boundary for connection with respect to the two-dimensional model is input. In FIG. 15, the connection identifier “discharge valve entry” is set at the bold line portion of the two-dimensional model.

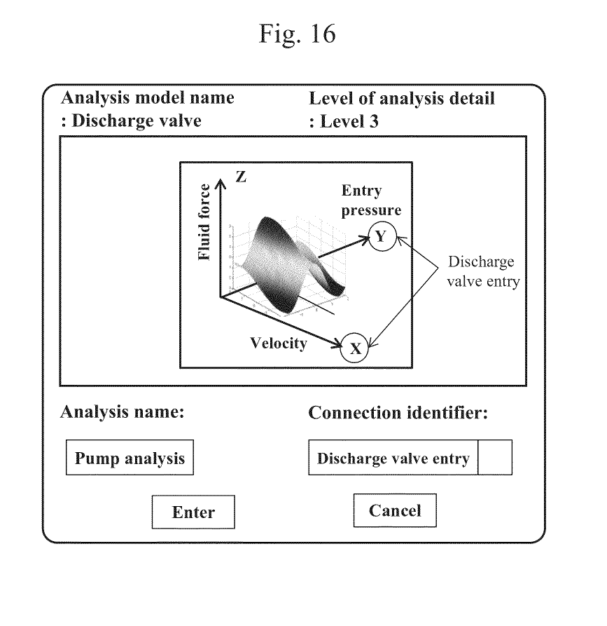

Finally, the operator the inputs boundary connection information with respect to the analysis model of the discharge valve with the level of analysis detail of “level 3” shown in FIG. 8. FIG. 16 illustrates an example of the boundary connection information input screen, where an approximation formula of the discharge valve is input, and a graph visualizing the approximation formula as an analysis model is displayed. There are also displayed the analysis model name “discharge valve” and the level of analysis detail “level 3” that have been input by the analysis model input/display unit 101. Herein, for connection with the previously input analysis model of the pressurizing chamber, “pump analysis” is input by the operator as the analysis name. Similarly, “discharge valve entry” is input for the connection identifier name, and a variable for connection with respect to the approximation formula is input. In FIG. 16, the connection identifier “discharge valve entry” is set for “X” and “Y”.

In S303 of S300, the boundary connection information input in S302 is acquired by the boundary connection information input/display unit 103.

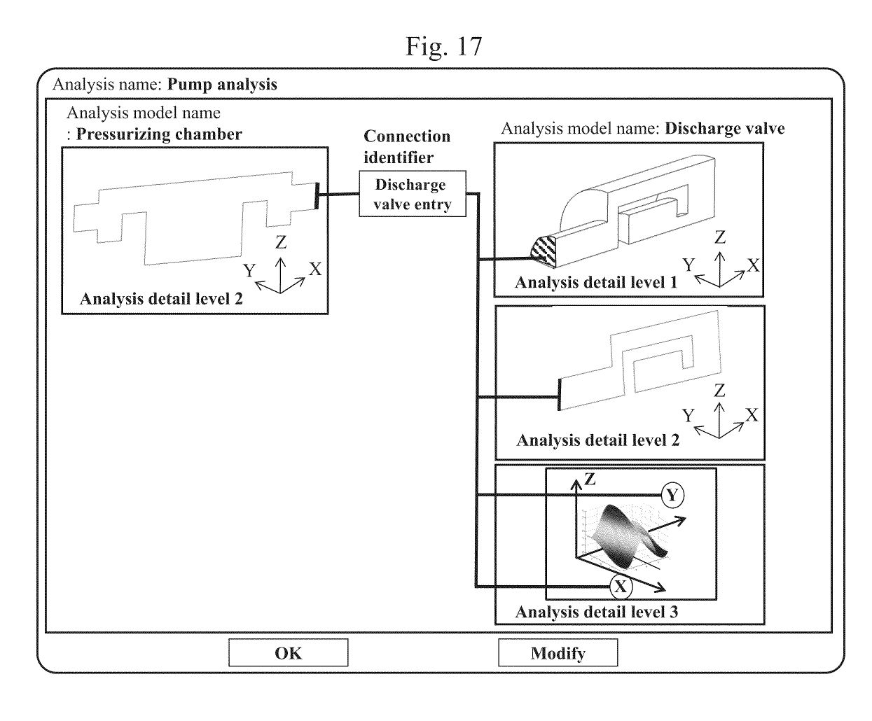

In S304 of S300, the boundary connection information input/display unit 103 displays, based on the information obtained in S303, a screen for confirming the connection relationship between the analysis models created with respect to different analysis domains. FIG. 17 illustrates an example of the confirmation screen, where, from the analysis models for which “pump analysis” is input in the analysis name and the boundary connection information input for the analysis models, a connection relationship between the analysis models where “pump analysis” is input in the analysis name is constructed by the boundary connection information input/display unit 103. In FIG. 17, the “pump analysis” is displayed as the analysis name of the connected analysis models, and also the analysis models of the pressurizing chamber and the discharge valve and the level of analysis detail of each analysis model with the analysis model name are displayed. In FIG. 17, the connection identifier “discharge valve entry” is displayed, and at the respective levels of analysis detail, the connected portion of the pressurizing chamber and the discharge valve via the “discharge valve entry”, i.e., the location where the boundary condition data is exchanged is displayed in a visualized manner.

In S305 of S300, the operator determines whether the connection relationship between the analysis models displayed in S304 is correct. If the connection relationship is correct, the operator presses the OK button shown in FIG. 17 and proceeds to S306. If the connection relationship is wrong, the operator presses the modify button shown in FIG. 17 and returns to S302, and inputs the connection relationship again.

In S306 of S300, the information obtained in S303 is input to the database 107 by the boundary connection information input/display unit 103.

Then, as shown in FIG. 4, in S400 of the second phase, the analysis model creation/analysis control unit 105, based on the analysis model information, the analysis condition information, the boundary connection information, and the analysis execution process information, constructs an analysis model (whole integrated analysis model) connecting the analysis models present in a plurality of analysis domains, mesh-generates the analysis model as necessary, and executes analytical calculation for the connected analysis model by exchanging boundary information in accordance with the designated level of analysis detail.

Specifically, in S401 of S400, the information input by the analysis model input/display unit 101, the analysis condition input/display unit 102, and the boundary connection information input/display unit 103 in S100, S200, and S300 are acquired from the database 107 by the analysis model creation/analysis control unit 105.

In S402 of S400, the analysis execution process input/display unit 104 displays an analysis execution process input screen. Via the analysis execution process input screen, the operator inputs information required for executing performance analysis of the mechanical structure.

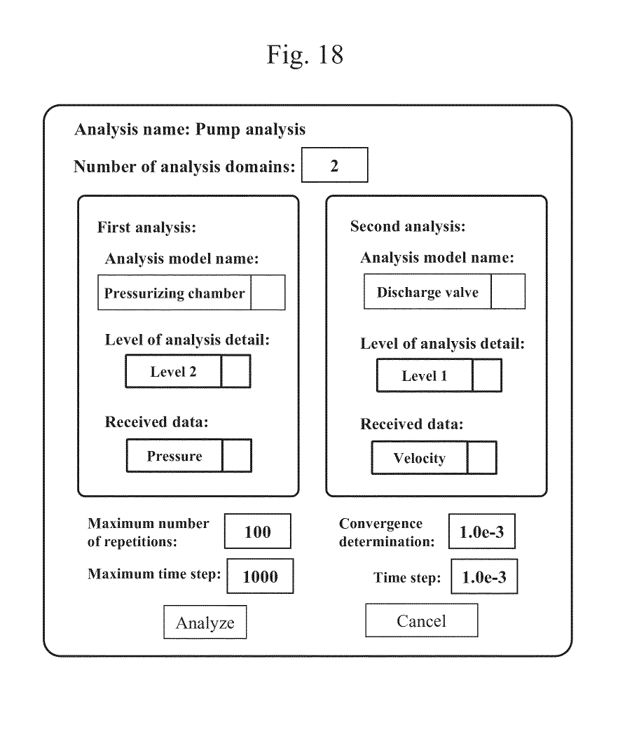

FIG. 18 illustrates an example of the analysis execution process input screen, where, in order to analyze the analysis model in which the analysis models created with respect to the two analysis domains of the flow passageway portion of the pressurizing chamber and the flow passageway portion of the discharge valve are connected by the connection identifier, “pump analysis” is displayed as the analysis name. Herein, for the number of analysis domains, the operator inputs “2” because there are the two domains of the pressurizing chamber and the discharge valve. Further, because “2” is input in the number of analysis domains, it is necessary to input the analysis models utilized for analysis, the levels of analysis detail of the analysis models, and the received data at the connected boundaries with respect to the two analysis domains. First, for the first analysis, in view of the direction of the flow of fluid, the operator inputs “pressurizing chamber” in the analysis model name. Further, because the level of analysis detail of the pressurizing chamber is only “level 2”, “level 2” is input. Then, as the received data at the connection boundary of the discharge valve as the object of connection of the pressurizing chamber, “pressure” is input. Then, for the second analysis, the operator inputs “discharge valve” in the analysis model name. While “level 1”, “level 2”, or “level 3” may be input as the level of analysis detail of the discharge valve, herein “level 1” is input in order to perform three-dimensional fluid analysis. Next, as the received data at the connection boundary of the pressurizing chamber as the object of connection of the discharge valve, “speed” is input. Then, “100” is input as the maximum number of repetitions, “1.0e-3” is input as the convergence determination, “1000” is input as the maximum time step, and “1.0e-3” is input as the time step.

In S403 of S400, in accordance with the analysis model information of the pressurizing chamber and the discharge valve, the analysis condition information, the analysis connection information, and the information input in S402 via the analysis execution process input screen (analysis execution process information), the analysis model creation/analysis control unit 105 constructs an analysis model connecting the analysis models present in a plurality of analysis domains. Namely, by using the analysis model for two-dimensional fluid analysis for the pressurizing chamber and the analysis model for three-dimensional fluid analysis for the discharge valve, the connected portions of the analysis models are identified by the connection identifier provided to the boundaries having the same meaning, and an analysis model in which the analysis models present in different analysis domains are connected is constructed. At this time, mesh-generation is also conducted because the analysis models of the pressurizing chamber and the discharge valve are “shape models”.

In S404 of S400, by the analysis model creation/analysis control unit 105, boundary information is set in an analysis model at the connection destination on the basis of the boundary connection information input in S300 in the analysis model for which analytical calculation is to be executed. Specifically, pressure information is acquired from the boundary of the discharge valve linked to the connection identifier “discharge valve entry”, and the pressure information is set at the boundary of the pressurizing chamber linked to the connection identifier “discharge valve entry”. For the pressure in the first analysis, the pressure in the initial state is set.

In S405 of S400, the I-th analysis is performed by the analysis model creation/analysis control unit 105. Specifically, first, the first analysis is performed, and, initially, based on the analysis condition information input by the analysis condition input/display unit 102 in S200, a two-dimensional fluid analysis for the pressurizing chamber is performed.

In S406 of S400, it is determined whether the analysis has been performed for the number I of analysis domains (Namely, whether all of the analysis has been completed for the number I of analysis domains) by the analysis model creation/analysis control unit 105. If it is determined that the analysis for all analysis domains has not been completed, the process proceeds to S404. If it is determined that the analysis for all analysis domains has been completed, the process proceeds to S407. Herein, for example, for the second analysis, based on the analysis condition information input by the analysis condition input/display unit 102 in S200, a three-dimensional fluid analysis of the discharge valve is performed. At this time, at the boundary of the discharge valve linked to the connection identifier “discharge valve entry”, the speed information acquired from the boundary of the pressurizing chamber is set.

If it is determined in S406 of S400 that the analysis for all analysis domains has been completed, it is determined in S407 of S400 whether a convergence determination is satisfied, or whether the number of repetitions has reached the maximum number of repetitions by the analysis model creation/analysis control unit 105. If it is determined that the convergence determination is not satisfied and the maximum number of repetitions has not been reached, the number I is set such that I=1 and the process proceeds to S404. If it is determined that the convergence determination is satisfied, or the maximum number of repetitions has been reached, the process proceeds to S408.

In S408 of S400, it is determined whether the maximum time step is reached by the analysis model creation/analysis control unit 105. If it is determined that the maximum time step is not reached, T is set such that T=T+ΔT so as to advance the progressing time of analysis by the time step ΔT and the process proceeds to S404. If it is determined that the maximum time step is reached, the process proceeds to S409.

In S409 of S400, the analysis result obtained in S404 to S409 is acquired and input to the database 107 by the analysis model creation/analysis control unit 105.

Then, in S500 of the second phase, the analysis result calculated by the analysis model creation/analysis control unit 105 is displayed by the analysis result display unit 106.

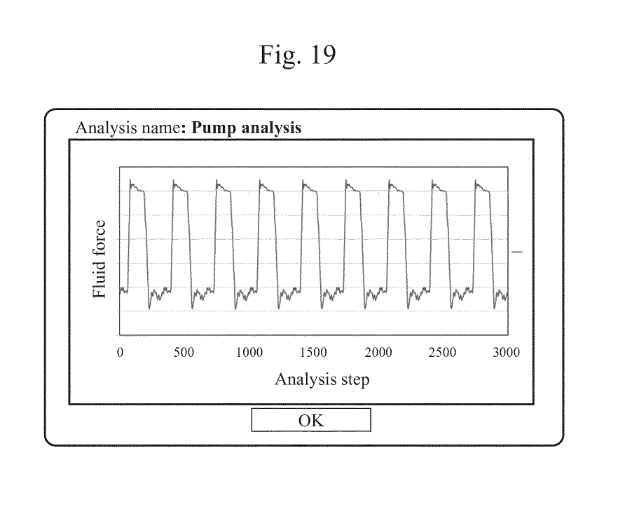

Specifically, in S501 of S500, the analysis result (calculated by the analysis model creation/analysis control unit 105) is displayed in a display screen as shown in FIG. 19, of which the horizontal axis shows the analysis step and the vertical axis shows the fluid force applied to the discharge valve, for example.

Next, a method of performing performance analysis by setting a different level of analysis detail from the level of analysis detail shown in FIG. 18 will be described. Detailed description of the processing procedure of S100, S200, and S300 shown in FIG. 3, and the processing procedure of S500 shown in FIG. 4 will be omitted, as they are the same in the present method as in the above-described example. Herein, the processing procedure of S400 shown in FIG. 4 will be described.

When a level of analysis detail different from the level of analysis detail shown in FIG. 18 (the level of analysis detail “level 1” of the discharge valve) is set, in S401 of S400, the information input by the analysis model input/display unit 101, the analysis condition input/display unit 102, and the boundary connection information input/display unit 103 in S100 are acquired from the database 107 by the analysis model creation/analysis control unit 105.

In S402 of S400, an analysis execution process input screen is displayed by the analysis execution process input/display unit 104. Via the analysis execution process input screen, the operator inputs information required for executing performance analysis of the mechanical structure.

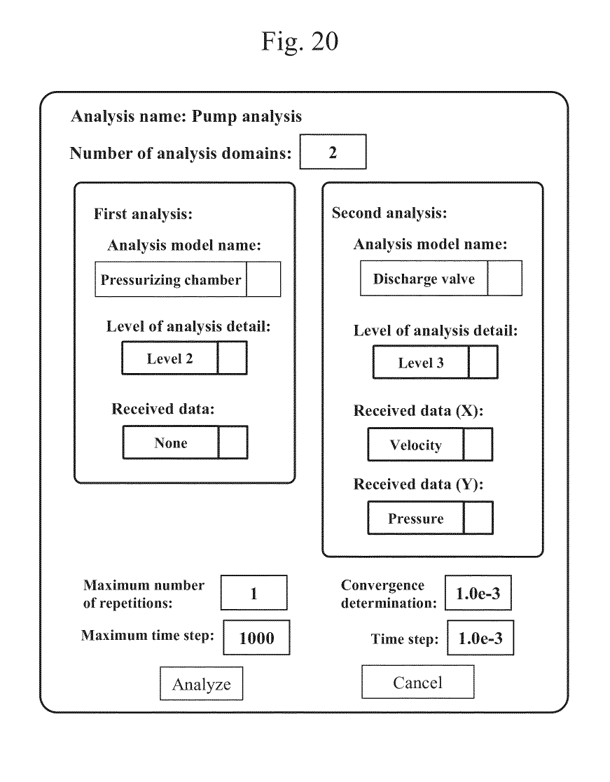

FIG. 20 illustrates an example of the analysis execution process input screen, where, in order to analyze an analysis model in which the analysis models present in two analysis domains of the flow passageway portion of the pressurizing chamber and the flow passageway portion of the discharge valve are connected by the connection identifier, “pump analysis” is displayed as the analysis name. Herein, for the number of analysis domains, “2” is input by the operator because there are the two domains of the pressurizing chamber and the discharge valve. Further, because “2” is input in the number of analysis domains, it is necessary to input the analysis models utilized for analysis, the levels of analysis detail of the analysis models, and the received data at the connected boundaries with respect to the two analysis domains. First, for the first analysis, in view of the direction of the flow of fluid, “pressurizing chamber” is input by the operator in the analysis model name. Further, because the level of analysis detail of the pressurizing chamber is only “level 2”, “level 2” is input. Then, for the received data at the connection boundary of the discharge valve as the object of connection of the pressurizing chamber, “None” is input because an approximation formula is utilized for analyzing the discharge valve at the connection destination. Next, for the second analysis, “discharge valve” is input by the operator in the analysis model name. While “level 1”, “level 2”, or “level 3” may be input as the level of analysis detail of the discharge valve, herein “level 3” is input because an analysis using an approximation formula is performed. Then, for the received data at the connection boundary of the pressurizing chamber as the object of connection of the discharge valve, because the analyze identifier “discharge valve entry” is input in “X” and “Y” for the input of the boundary information with the level of analysis detail “level 3” for the discharge valve in S302, there are two received data, so that “speed” is input in received data (X) and “pressure” is input in received data (Y). Then, for the maximum number of repetitions, because there is no received data in the analysis of the pressurizing chamber for the first analysis, “1” is input, meaning there is no repetition. Then, for the convergence determination, “1.0e-3” is input. This numerical value for convergence determination is disregarded because there is no repetition. Then, “1000” is input as the maximum time step, and “1.0e-3” is input as the time step.

In S403 of S400, in accordance with the analysis model information of the pressurizing chamber and the discharge valve, the analysis condition information, the analysis connection information, and the information input in S402 via the analysis execution process input screen (analysis execution process information), the analysis model creation/analysis control unit 105 constructs an analysis model connecting the analysis models present in a plurality of analysis domains. Namely, by using the analysis model for two-dimensional fluid analysis for the pressurizing chamber and the analysis model of an approximation formula for the discharge valve, the connected portions of the analysis models are identified by the connection identifier provided to the boundaries having the same meaning, and an analysis model in which the analysis models present in different analysis domains are connected is constructed. At this time, mesh-generation is also conducted because the analysis model of the pressurizing chamber is a “shape model”.

In S404 of S400, by the analysis model creation/analysis control unit 105, boundary information is set in an analysis model at the connection destination on the basis of the boundary connection information input in S300 in the analysis model for which analytical calculation is to be executed. Specifically, in the analysis of the pressurizing chamber, because of the absence of the received data, the pressure set in S202 is set (see FIG. 12).

In S405 of S400, the I-th analysis is performed by the analysis model creation/analysis control unit 105. Specifically, first, the first analysis is performed, and, initially, based on the analysis condition information input by the analysis condition input/display unit 102 in S200, a two-dimensional fluid analysis for the pressurizing chamber is performed.

In S406 of S400, it is determined whether the analysis has been performed for the number I of analysis domains (Namely, whether all of the analysis has been completed for the number I of analysis domains) by the analysis model creation/analysis control unit 105. If it is determined that the analysis for all analysis domains has not been completed, the process proceeds to S404. If it is determined that the analysis for all analysis domains has been completed, the process proceeds to S407. Herein, for example, for the second analysis, an analytical calculation is performed using the approximation formula of the discharge valve on the basis of the analysis condition information input by the analysis condition input/display unit 102 in S200. At this time, of the two boundaries of the discharge valve linked to the connection identifier “discharge valve entry”, the speed information acquired from the boundary of the pressurizing chamber is input in “X”, and the pressure information acquired from the boundary of the pressurizing chamber is input in “Y”.

If it is determined in S406 of S400 that the analysis for all analysis domains has been completed, it is determined in S407 of S400 whether a convergence determination is satisfied, or whether the number of repetition has reached the maximum number of repetitions by the analysis model creation/analysis control unit 105. Herein, as described above, because “1” is input for the maximum number of repetitions, the process automatically proceeds to S408.

In S408 of S400, it is determined whether the maximum time step is reached by the analysis model creation/analysis control unit 105. If it is determined that the maximum time step is not reached, T is set such that T=T+ΔT so as to advance the progressing time of analysis only by time step AT and the process proceeds to S404. If it is determined that the maximum time step is reached, the process proceeds to S409.

In S409 of S400, the analysis result obtained in S404 to S409 is acquired and input to the database 107 by the analysis model creation/analysis control unit 105.

Thus, according to the present embodiment, when whole integrated analysis linking a plurality of analysis domains is performed, in order to set a boundary condition connecting analysis models created with respect to different analysis domains, a common (single) connection identifier is given to the boundaries having the same meaning, and performance analysis is implemented utilizing a unified whole integrated analysis model connecting analysis models created with respect to a plurality of analysis domains via the connection identifier. By relating the analysis models using such connection identifier, when calculating the performance, such as efficiency, of the system as a whole of a mechanical structure such as a fluid pump, even when analysis models with different levels of detail are switched, it is not necessary to newly input connection information, and a whole integrated analysis model connecting the analysis models for the respective analysis domains can be easily constructed. Further, even when an analysis model with a different level of analysis detail is newly added, it is not necessary to directly link the analysis model to the boundary of each analysis model having a different level of analysis detail at the connection destination, so that an analysis model in which the analysis models present in a plurality of analysis domains are connected can be easily constructed by coupling the analysis model to the connection identifier. Thus, the construction time of the analysis model and the analyzing work time for performance analysis can be effectively reduced.

In addition, according to the present embodiment, a map representing the connection relationship between analysis models is created from the boundary connection information of the analysis models connected via the connection identifier, and the map is displayed to the operator via a display screen. Particularly, the map is displayed to the operator via the display screen while the connected portion of each analysis model linked to the connection identifier is shown. Thus, the operator can easily grasp a boundary condition setting error of the analysis model and the like, so that a whole integrated analysis model used for performance analysis can be accurately constructed.

In the foregoing embodiment, when an approximation formula is used for the second (discharge valve) analysis, the received data for the first (pressurizing chamber) analysis is “None”. However, an approximation formula necessary for the exchange for the first analysis may be input for the analysis model of the discharge valve, and the received data for the first analysis may be input.

In the foregoing embodiment, a polynomial is used for the approximation formula used for discharge valve analysis. However, it is also possible to input a response curve model, such as a look-up table or a neural network.

In the foregoing embodiment, three levels of analysis detail are input as the level of analysis detail of the analysis model of the discharge valve. However, it is also possible to input an analysis model having other levels of analysis detail by inputting a new level of analysis detail. In addition, while the analysis model having one level of analysis detail has been input as the analysis model of the pressurizing chamber, it is also possible to input an analysis model of the pressurizing chamber having other levels of analysis detail by inputting a new level of analysis detail.

While, in the foregoing embodiment, an unsteady fluid analysis is implemented as performance analysis for the mechanical structure, it is also possible to implement a steady fluid analysis.

Further, while, in the foregoing embodiment, the analytical calculation for the respective analysis domains is implemented using the same computer, it is also possible to implement the analytical calculation for the respective analysis domains using different computers by utilizing a network environment, for example.

The present invention is not limited to the foregoing embodiment and may include various modifications. The foregoing embodiment has been described in detail for facilitating an understanding of the present invention, and is not limited to have all of the configurations described. Some of the configuration of one embodiment may be substituted by the configuration of another embodiment, or the configuration of the other embodiment may be incorporated into the configuration of the one embodiment. With respect to some of the configuration of an embodiment, addition, deletion, or substitution of other elements may be made.

The configurations, functions, processing units, processing means and the like may be partly or entirely designed for an integrated circuit for hardware implementation. The configurations, functions and the like may be implemented by software by having a processor interpret and execute a program for realizing the individual functions. Information about the programs, tables, files and the like for implementing the functions may be stored in a storage device such as a memory, a hard disk, or a solid state drive (SSD), or a recording medium such as an IC card, an SD card, or a DVD.

The illustrated control lines or information lines are only those considered necessary for description purpose and do not necessarily show all of control lines or information lines required in an actual product. It may be considered that in practice almost all elements are mutually connected.

### DESCRIPTION OF SYMBOLS

100 Whole integrated analysis model creation assist device
101 Analysis model input/display unit
102 Analysis condition input/display unit
103 Boundary connection information input/display unit
104 Analysis execution process input/display unit
105 Analysis model creation/analysis control unit
106 Analysis result display unit
107 Database
108 Computer

What is claimed is:

1. A whole integrated analysis model creation assist device for assisting creation of a whole integrated analysis model integrating analysis models created with respect to a plurality of analysis domains, wherein
the whole integrated analysis model creation assist device is configured to connect and integrate, via a connection identifier associating boundaries for data exchange between an analysis model created with respect to one of the analysis domains and an analysis model created with respect to another of the analysis domains, at least one analysis model created with respect to the one analysis domain with a plurality of analysis models created with respect to the other analysis domain.

2. The whole integrated analysis model creation assist device according to claim 1, wherein the whole integrated analysis model creation assist device is configured to display a connection relationship between the analysis models via the connection identifier.

3. The whole integrated analysis model creation assist device according to claim 2, wherein the whole integrated analysis model creation assist device is configured to display a connected portion of each analysis model linked to the connection identifier.

4. The whole integrated analysis model creation assist device according to claim 1, wherein the whole integrated analysis model creation assist device is configured to execute performance analysis with respect to each analysis domain based on the analysis model created with respect to the one analysis domain and the analysis models created with respect to the other analysis domain which are connected via the connection identifier.

5. A whole integrated analysis model creation assist method for assisting creation of a whole integrated analysis model integrating analysis models created with respect to a plurality of analysis domains,
the method comprising connecting and integrating, via a connection identifier associating boundaries for data exchange between an analysis model created with respect to one of the analysis domains and an analysis model created with respect to another of the analysis domains, at least one analysis model created with respect to the one analysis domain with a plurality of analysis models created with respect to the other analysis domain.

6. The whole integrated analysis model creation assist method according to claim 5, comprising displaying a connection relationship between the analysis models via the connection identifier.

7. The whole integrated analysis model creation assist method according to claim 6, comprising displaying a connected portion of each analysis model linked to the connection identifier.

8. The whole integrated analysis model creation assist method according to claim 5, comprising executing performance analysis with respect to each analysis domain based on the analysis model created with respect to the one analysis domain and the analysis models created with respect to the other analysis domain which are connected via the connection identifier.

9. The whole integrated analysis model creation assist method according to claim 5, including a step of displaying analysis model information concerning the analysis models, a step of displaying analysis condition information concerning an analysis condition, and a step of displaying boundary connection information concerning boundary connection between the analysis models and including the connection identifier.
